(19) United States
(12) Patent Application Publication
(10) Pub. No.: US 2015/0084996 A1
(43) Pub. Date: Mar. 26, 2015

(54) DISPLAY CONTROL CIRCUIT, LIQUID CRYSTAL DISPLAY DEVICE PROVIDED THEREWITH, AND DISPLAY CONTROL METHOD

(71) Applicant: Sharp Kabushiki Kaisha, Osaka (JP)

(72) Inventor: Ryo Yamakawa, Osaka (JP)

(73) Assignee: SHARP KABUSHIKI KAISHA, Osaka (JP)

(21) Appl. No.: 14/395,579

(22) PCT Filed: Apr. 18, 2013
(86) PCT No.: PCT/JP2013/061437

§ 371 Date: Oct. 20, 2014

(30) Foreign Application Priority Data
Apr. 25, 2012 (JP) 2012-099652

(51) Int. Cl. G09G 3/36

(52) U.S. Cl. CPC G09G 3/3607; G09G 2320/0233; G09G 2320/0242; G09G 2320/0271
USPC 345/690

(57) ABSTRACT

In a liquid crystal display device that performs white balance adjustment, the difference between hues during still image display and hues during moving image display can be reduced. In a display control circuit used in the liquid crystal display device that performs white balance adjustment, an R overshoot LUT, a G overshoot LUT, and a B overshoot LUT are provided as tables for overshoot parameters. The overshoot parameters are determined for each color among red, green, and blue such that, the more the white balance parameter of a particular color has a maximum value corresponding to applied voltage to liquid crystal lowered by a white balance processing circuit, the more the signal time shift will be emphasized through correction by an overshoot driving circuit.

### TECHNICAL FIELD

The present invention relates to a display control circuit, and in particular to a display control circuit that performs white balance adjustment provided in a liquid crystal display device.

### BACKGROUND ART

In liquid crystal display devices such as liquid crystal televisions, white hues are sometimes different for each device due to production variations in the backlight or liquid crystal panel hues. In general, the hues of the liquid crystal display devices are kept uniform by performing white balance adjustment with parameters (white balance parameters) that differ depending on the device. White balance parameters are prescribed parameters for the colors R (red), G (green), and B (blue) and adjust the maximum value of the output to the panel. At this time, the production variation in the backlight and the hues of the liquid crystal panel are offset by improving the balance among R, G, and B, thereby maintaining uniform hues as described above.

White balance adjustment will now be explained. In white balance adjustment, values (gradation values) of gradation data included in input image signals are corrected for each color so that white can be displayed properly, regardless of the color temperature of the backlight light source, for example. To perform this correction, a look-up table (hereinafter, “white balance adjustment LUT”) such as the one shown in FIG. 11, for example, is provided. As shown in FIG. 11, in the white balance adjustment LUT, there are post-correction gradation values (gradation values after white balance adjustment) for the input gradation value and R (red color), G (green color), and B (blue color). In the row marked by reference character 91, for example, it is shown that the post-correction gradation value of R data having an input gradation value of “250” is “247,” the post-correction gradation value of G data having an input gradation value of “250” is “207,” and the post-correction gradation value of B data having an input gradation value of “250” is “250.” If there is pixel data in which the input gradation values for R, G, and B are “250,” “255,” and “251,” respectively, then as shown in FIG. 12, the post-correction gradation values for R, G, and B in this pixel data would be “247,” “210,” and “251,” respectively. In this manner, correction of gradation values is performed using the white balance parameters of the respective colors, thereby correctly displaying white on the screen.

There are times when image quality is insufficient during moving display of the liquid crystal display device due to slow response speed of the liquid crystal. In order to suppress a drop in image quality during moving display, a driving method called overshoot driving is conventionally used. During overshoot driving, an input image signal of an immediately preceding frame and an input image signal of the current frame are paired together, and a driving voltage that is higher or lower than a prescribed gradation voltage corresponding to the current frame input image signal is supplied to the liquid crystal panel in accordance with this pairing. By using this type of overshoot driving, the time it takes for the liquid crystal to reach the desired transmittance is shortened, which suppresses a drop in image quality during moving display by the liquid crystal display device.

An invention that is similar to this is described in Japanese Patent Application Laid-Open Publication No. 2007-233061, in which a liquid crystal display device performs a suitable degree of overshoot driving on the basis of whether transmissive mode or reflective mode should be used in accordance with the intensity of ambient light.

### RELATED ART DOCUMENT

### Patent Document

Patent Document 1: Japanese Patent Application Laid-Open Publication No. 2007-233061

### SUMMARY OF THE INVENTION

### Problems to be Solved by the Invention

As shown by the row in FIG. 11 marked by reference character 92, with an input gradation value of “255,” the post-correction gradation value of R, G, and B would be “250,” “210,” and “255,” respectively. Therefore, compared to R and B, G has the maximum gradation value thereof markedly lowered by the white balance adjustment. Accordingly, in pixels displaying green, the overall voltage applied to the liquid crystal will be smaller than for pixels displaying red or blue.

FIG. 13 shows changes in luminance for each color when black display and white display are repeated every frame, in a liquid crystal display device in which white balance adjustment is being performed using a white balance adjustment LUT such as that shown in FIG. 11. In FIG. 13, the thin solid line shows changes in luminance of R, the thick solid line shows changes in luminance of G, and the thick dotted line shows changes in luminance of B. As understood from FIG. 13, the response characteristics of G are worse than R or B. Due to this, in pixels displaying a color with a low maximum value white balance parameter, the charge applied to the liquid crystal is smaller overall, and the response speed of the liquid crystal is relatively slower. This does not have much effect on hues during still image display. During moving image display, however, there is a risk that the desired hues will not be achieved due to the difference in response speed of liquid crystal among R, G, and B. When white display is supposed to be performed, for example, R and B will be more strongly displayed than G, which will make the actual display color a white color with a purple tinge.

The present invention aims at reducing the difference between hues during still image display and moving image display in a liquid crystal display device that performs white balance adjustment.

### Means for Solving the Problems

A first aspect of the present invention is a display control circuit that generates gradation data to be written to a liquid crystal display panel that displays images on the basis of image signals expressing gradation levels for colors including red, green, and blue, the display control circuit including: a white balance processing unit that corrects the gradation level of each color expressed by the image signals using white balance parameters determined for each of the gradation levels of each color of red, green, or blue; and an overshoot driving unit that generates the gradation data for image display, the overshoot driving unit generating prescribed overshoot parameters to be written in accordance with a current frame gradation level to be applied in the current frame and a gradation level that has been written in an immediately preceding frame so as to emphasize a signal time shift for each of the colors among red, green and blue with respect to the post-corrected image signal, wherein among the respective colors, the more the white balance processing unit decreases a maximum level of applied voltage to liquid crystal of a particular color, the greater the overshoot driving unit emphasizes the signal time shift for that particular color among red, green, and blue.

A second aspect of the present invention is the first aspect of the present invention, further including, for each of the colors, overshoot tables defined by: a current frame gradation level; a gradation level that has been written in an immediately preceding frame; and an output gradation level for every combination of current frame gradation level and a gradation level that has been written in an immediately preceding frame, wherein the overshoot driving unit emphasizes the signal time shift of the respective colors based on the from the overshoot table of the corresponding color.

A third aspect of the present invention is the first aspect of the present invention, further including: overshoot tables that store for each of the colors: a current frame gradation level; a gradation level that has been written in an immediately preceding frame; and an output gradation level corresponding to a combination of the current frame gradation level and the gradation level that has been written in an immediately preceding frame, wherein the overshoot driving unit emphasizes the signal time shift of the respective colors using a calculation including a product of a output gradation level and a prescribed coefficient of the corresponding color as an overshoot parameter.

A fourth aspect of the present invention is the third aspect of the present invention, wherein the overshoot parameter is found by the calculation in a formula: V=P+(Q−P)×C, and wherein V represents the overshoot parameter, P represents a gradation level that has been written in an immediately preceding frame, Q represents an output gradation level, and C represents the coefficient of the corresponding color.

A fifth aspect of the present invention is the third aspect of the present invention, wherein a plurality of the coefficients are stored for each of the colors, and wherein the overshoot driving unit selectively uses one of the plurality of stored coefficients in accordance with a gradation level in an immediately preceding frame and a current frame gradation level in performing the calculation.

A sixth aspect of the present invention is a liquid crystal display device, including: the display control circuit according to any one of the first to fifth aspects of the present invention; a liquid crystal display panel, including a plurality of image signal lines that transmit a plurality of image signals corresponding to the write gradation data for image display; a plurality of scan signal lines that intersect with the plurality of image signal lines; a plurality of pixel forming areas arranged in a matrix along the plurality of image signal lines and the plurality of scan signal lines; and a common electrode that applies a common voltage to the plurality of pixel forming areas; an image signal driving circuit that drives the plurality of image signal lines; and a scan signal driving circuit that drives the plurality of scan signal lines.

A seventh aspect of the present invention is a method of controlling display in which gradation data is generated that is to be written to a liquid crystal display panel that displays images on the basis of image signals expressing gradation levels for colors including red, green, and blue, the method including: performing white balance processing by adjusting the gradation level of each color expressed by the image signals using white balance parameters determined for each of the gradation levels of each color of red, green, or blue; and performing overshoot processing by generating the gradation data for image display, the overshoot processing generating prescribed overshoot parameters to be written in accordance with a current frame gradation level to be applied in the current frame and a gradation level that has been written in an immediately preceding frame so as to emphasize a signal time shift for each of the colors among red, green and blue with respect to the post-corrected image signal, wherein among the respective colors, the more a maximum level of applied voltage to liquid crystal of a particular color is decreased in the step of white balance processing, the greater the signal time shift for that particular color among red, green, and blue is emphasized in the step of overshoot processing.

### Effects of the Invention

According to the first aspect of the present invention, in a display control circuit for a liquid crystal display panel that performs white balance adjustment and overshoot driving, the overshoot parameters are configured for each color such that, the more the white balance parameter of a particular color has a maximum value corresponding to applied voltage to liquid crystal lowered by the white balance adjustment, the more the signal time shift will be emphasized. Accordingly, colors having the applied voltage to liquid crystal thereof lowered overall by white balance adjustment will have a suppression in the reduction in response speed (of liquid crystal) caused by a reduction in applied voltage to liquid voltage. This lowers the differences in response characteristics of liquid crystal among red, green, and blue regardless of difference in values of the white balance parameters among these colors. As a result, hues during moving image display can approximate hues during still image displays. In other words, it is possible to reduce the difference in hues during still image display and hues during moving image display.

According to the second aspect of the present invention, the overshoot parameters can be obtained from the overshoot table provided for each color, and thus, effects similar to the first aspect of the present invention can be achieved without increasing the processing load of the display control circuit.

According to the third aspect of the present invention, only one overshoot table needs to be provided; therefore, effects similar to the first aspect of the present invention can be achieved without increasing necessary memory load.

According to the fourth aspect of the present invention, similar effects to the first aspect of the present invention can be achieved without increasing necessary memory load, in a manner similar to the third aspect of the present invention.

According to the fifth aspect of the present invention, a plurality of coefficients used for the calculation process are provided for each color. This makes it possible to more precisely adjust the degree of emphasis of the signal time shift by the overshoot driving, which allows for the difference between hues during still image display and hues during moving image display to be more effectively reduced.

According to the sixth aspect of the present invention, a liquid crystal display device provided with a display control circuit that exhibits effects similar to any one of aspects one to five of the present invention is achieved.

According to the seventh aspect of the present invention, effects similar to the first aspect of the present invention can be achieved by an invention obtained by a method of display control.

### BRIEF DESCRIPTION OF THE DRAWINGS

FIG. 1 is a block view showing a configuration of a display control circuit in a liquid crystal display device according to Embodiment 1 of the present invention.

FIG. 2 is a block view showing the entire configuration of the liquid crystal display device in Embodiment 1.

FIG. 3 is a view showing one example of a white balance adjustment LUT in Embodiment 1.

FIG. 4 is a view schematically showing one example of an R overshoot LUT in Embodiment 1.

FIG. 5 is a view schematically showing one example of a G overshoot LUT in Embodiment 1.

FIG. 6 is a view schematically showing one example of a B overshoot LUT in Embodiment 1.

FIG. 7 is a view for explaining the effects in Embodiment 1.

FIG. 8 is a block view showing a configuration of a display control circuit in a liquid crystal display device according to Embodiment 2 of the present invention.

FIG. 9 is a view schematically showing one example of an overshoot LUT in Embodiment 2.

FIG. 10 is a view for explaining a modification example of Embodiment 2.

FIG. 11 is a view for explaining the white balance adjustment LUT.

FIG. 12 is a view for explaining correction of gradation values by white balance adjustment.

FIG. 13 is a view of a conventional example showing changes in luminance for each color when black display and white display are repeated every frame, in a liquid crystal display device in which white balance adjustment is being performed using white balance adjustment LUT such as that shown in FIG. 11.

### DETAILED DESCRIPTION OF EMBODIMENTS

Below, embodiments of the present invention will be explained with reference to figures.

### 1. Embodiment 1

### 1.1 Entire Configuration and Operating Summary

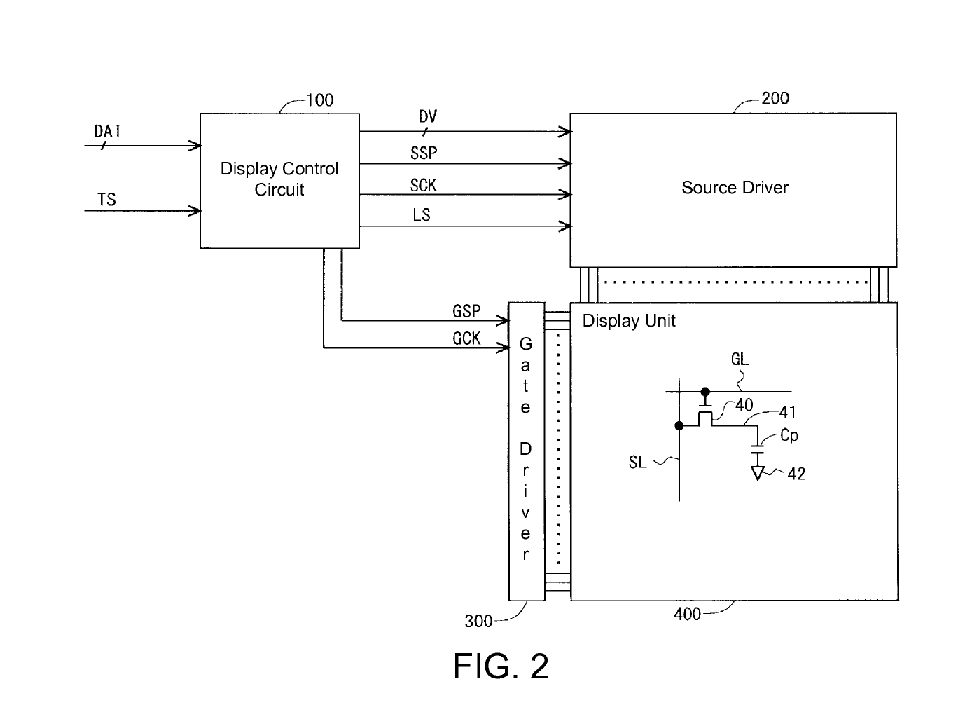

FIG. 2 is a block diagram showing a configuration of a liquid crystal display device according to Embodiment 1 of the present invention. This liquid crystal display device is constituted of a display control circuit 100, a source driver (image signal line driving circuit) 200, a gate driver (scan signal line driving circuit) 300, and a display unit 400. The display unit 400 has a plurality of source bus lines (image signal lines) SL and a plurality of gate bus lines (scan signal lines) GL. Pixel forming areas where pixels are formed are disposed at each intersection of the source bus lines SL and the gate bus lines GL. In other words, the display unit 400 has a plurality of pixel forming areas. These pixel forming areas are arranged in a matrix to form pixel arrays. Each pixel forming area has: a thin-film transistor (TFT) 40, which is a switching device having a gate terminal connected to the gate bus line GL passing through the corresponding intersection and a source terminal connected to the source bus line SL passing through the same intersection; a pixel electrode 40 connected to the drain terminal of the thin-film transistor 40; a common electrode 42 that is an opposite electrode for applying a common voltage to the plurality of pixel forming areas; and a liquid crystal layer sandwiched between the common electrode 42 and the pixel electrode 41, which is disposed in all of the plurality of pixel forming areas. The liquid crystal capacitance formed by the pixel electrode 41 and the common electrode 42 forms a pixel capacitance Cp. In general, auxiliary capacitances are arranged next to each other on the liquid crystal capacitance in order to reliably hold a voltage in the pixel capacitance Cp, but the auxiliary capacitances are not directly related to the present invention, and thus an explanation and drawing thereof will be omitted. In FIG. 2, only the constituting elements related to one pixel forming area in the display unit 400 are shown.

Next, the operation of these constituting elements shown in FIG. 2 will be explained. The display control circuit 100 receives timing signals TS such as synchronization signals or vertical synchronization signals from outside, and outputs digital image signals DV, source start pulse signals SSP, source clock signals SCK, and latch strobe signals LS for controlling operation of the source driver 200, and gate start pulse signals GSP and gate clock signals GCK for controlling operation of the gate driver 300.

The source driver 200 receives the digital image signals DV, the source start pulse signals SSP, the source clock signals SCK, and the latch strobe signals LS outputted from the display control circuit 100, and applies driving image signals to the respective source bus lines SL. At this time, the digital image signals DV, which express the voltage to be applied to the respective source bus lines SL in accordance with the pulses from the source clock signals SCK, are sequentially stored in the source driver 200. The stored image signals DV are converted to analog voltage in accordance with pulses of the latch strobe signals LS. The converted analog voltage is simultaneously applied to all of the source bus lines SL as driving image signals. The gate driver 300 repeatedly applies active scan signals to the respective gate bus lines GL based on the gate start pulse signals GSP and the gate clock signals GCK outputted from the display control circuit 100, with one vertical scan period as a cycle.

In this manner, driving image signals are applied to the respective source lines SL, and scan signals are applied to the respective gate bus lines GL, thereby displaying on the display unit 400 an image based on image signals DAT received from outside.

### 1.2 Display Control Circuit

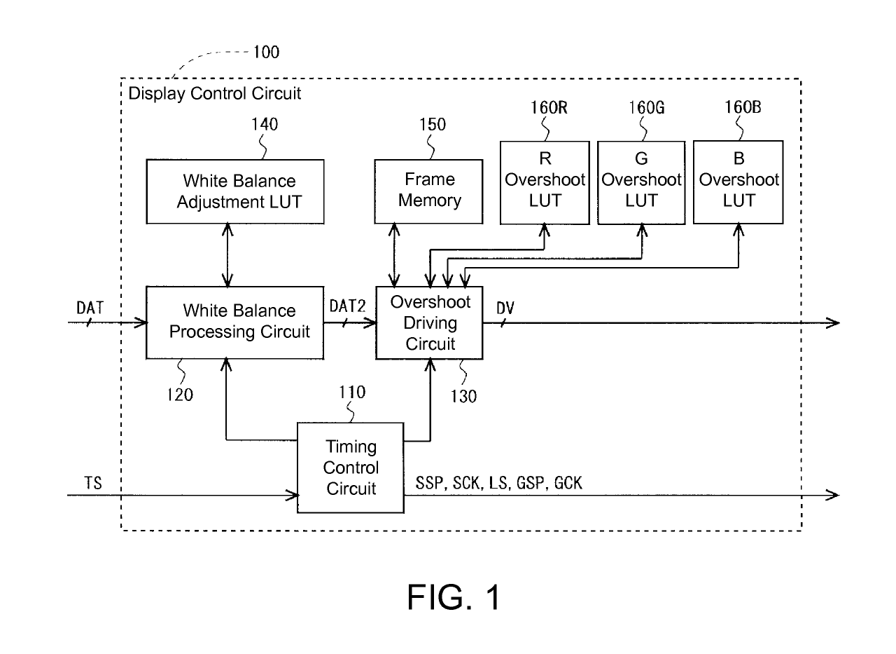

FIG. 1 shows a block view of the configuration of the display control circuit 100 of the present embodiment. This display control circuit 100 includes a timing control circuit 110, a white balance processing circuit 120, an overshoot driving circuit 130, a white balance adjustment LUT (look-up table) 140, a frame memory 150, and three overshoot LUTs (an R overshoot LUT 160R, a G overshoot LUT 160G, and a B overshoot LUT 160B). In this way, there are overshoot LUTs for the respective colors in the present embodiment.

The timing control circuit 110 controls operation of the white balance processing circuit 120 and the overshoot driving circuit 130 on the basis of the timing signals TS received from outside, and outputs the source start pulse signals SSP, the source clock signals SCK, the latch strobe signals LS, the gate start pulse signals GSP, and the gate clock signals GCK.

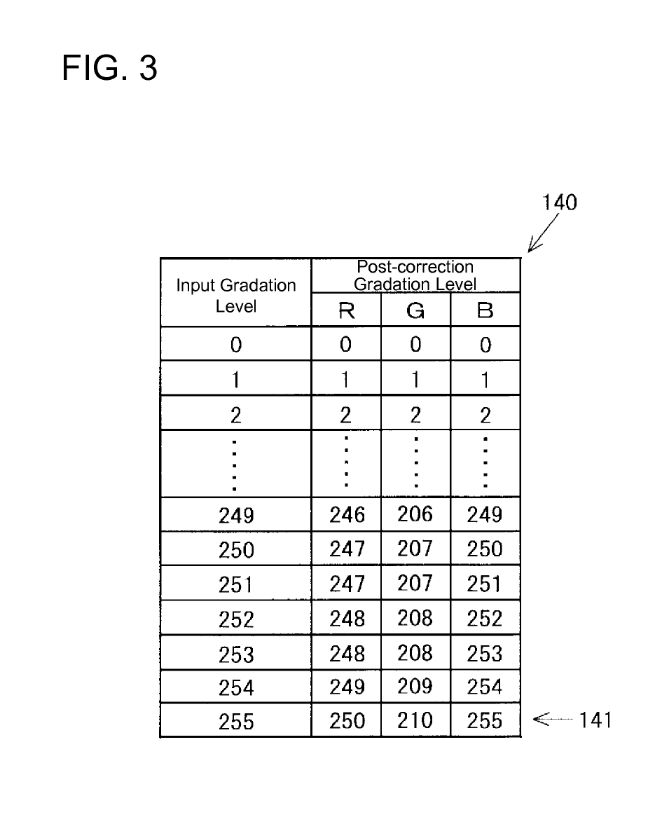

The white balance processing circuit 120 performs white balance adjustment that corrects the gradation data values (gradation data) included in the image signals DAT for each of the colors so that white can be correctly displayed regardless of color temperature of the backlight light source. The white balance adjustment LUT 140 is a table that is provided for this white balance adjustment. As shown in FIG. 3, in the white balance adjustment LUT 140, there are input gradation values and post-correction gradation values (gradation values after white balance adjustment) for R (red), G (green), and B (blue). The post-correction gradation value for R data having an input gradation value of “250” is “247,” for example. In this manner, the white balance processing circuit 120 corrects the image signal DAT on the basis of the white balance adjustment LUT 140 and outputs an image signal DAT2 expressing the above-mentioned post-correction gradation values. The parameters that express the post-correction gradation values for each of the input gradation values of R, G, and B are called the “white balance parameters.” In the example shown in FIG. 3, the G white balance parameters are smaller than the R and B white balance parameters overall.

The overshoot driving circuit 130 emphasizes the signal time shift for the image signals DAT2 that have been corrected by white balance processing circuit 120 in order to perform the above-mentioned overshoot driving and generates write gradation data expressing the applied gradation values for each of the pixel forming areas. This is outputted as the digital image signal DV. In this explanation, parameters that express a value corresponding to the applied gradation values of the respective pixel forming areas are called “overshoot parameters.”

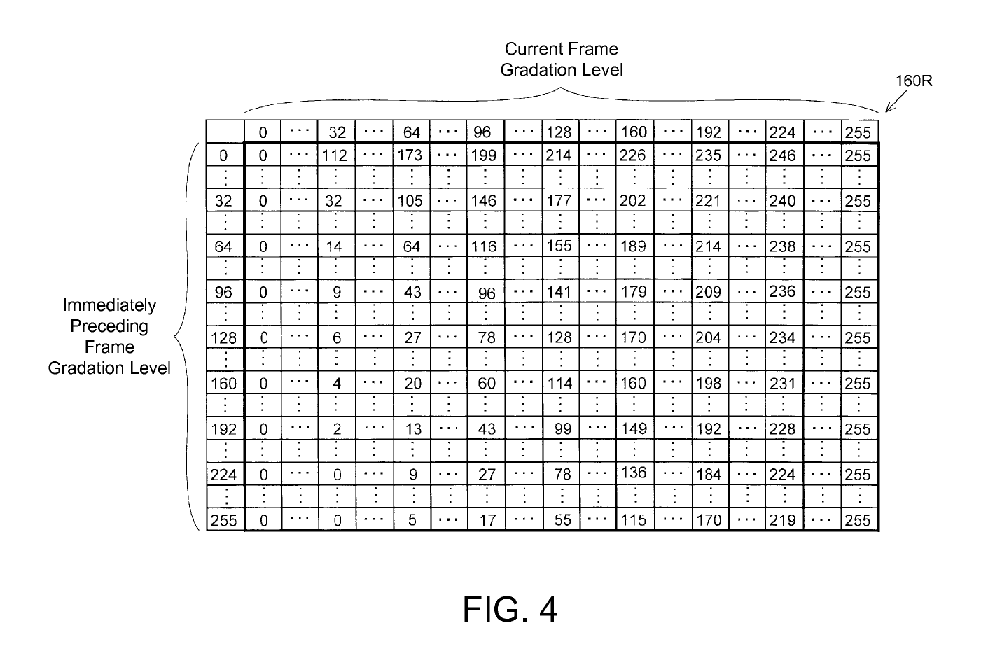

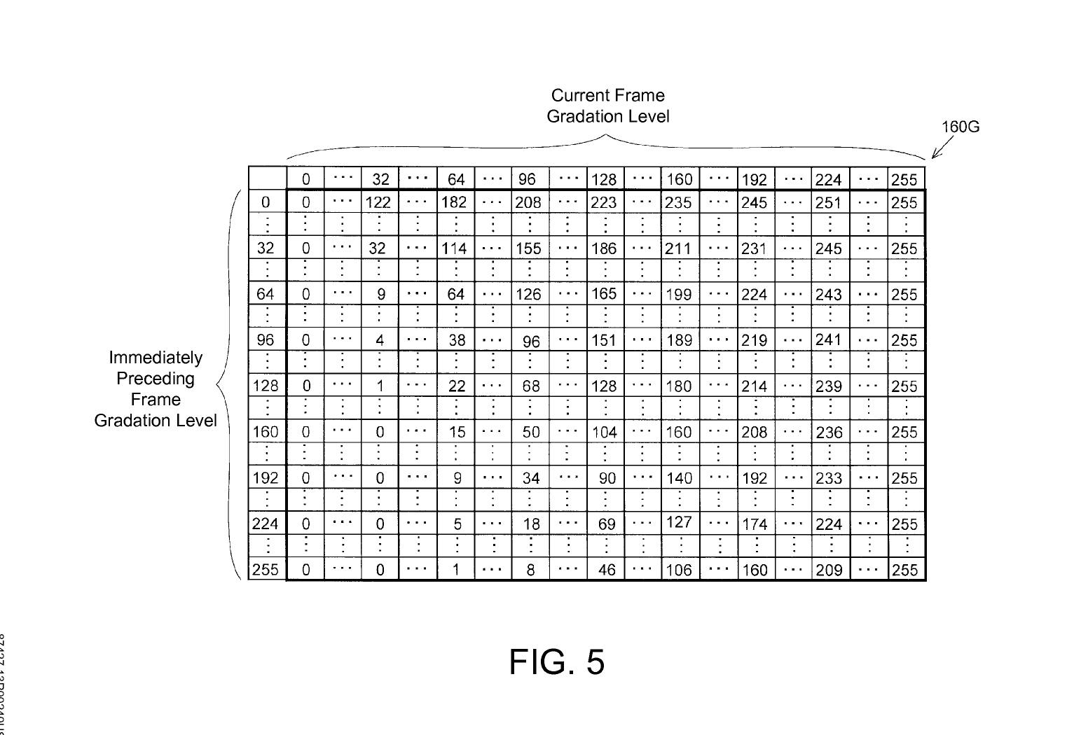

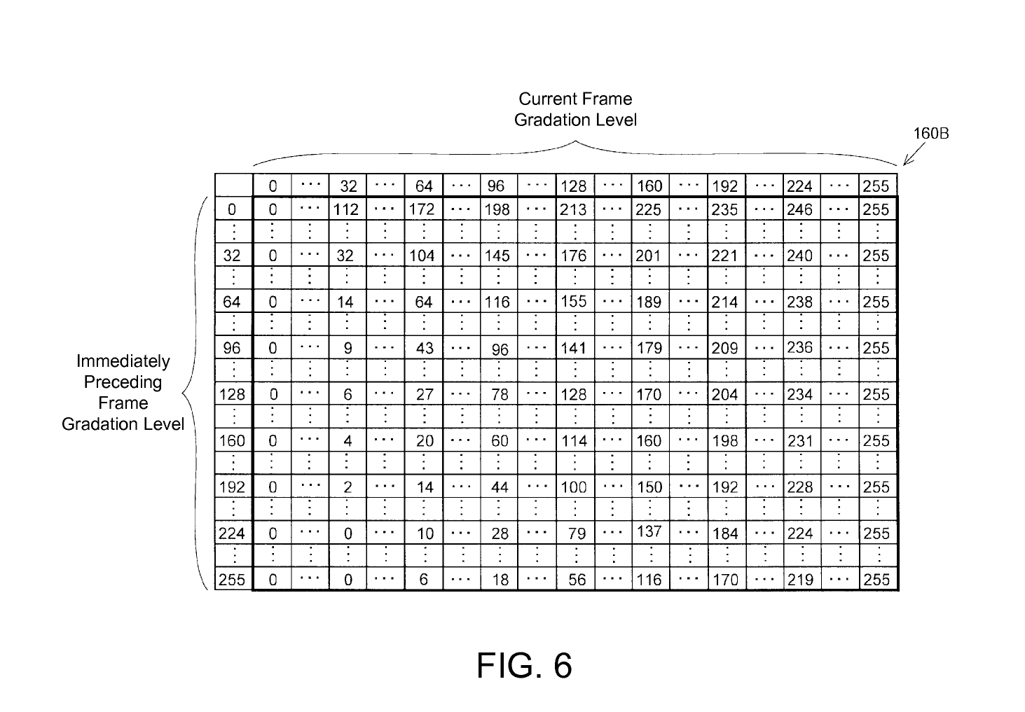

In liquid crystal display devices that use overshoot driving, look-up tables (overshoot LUTs) are stored so that the driving voltage will be determined on the basis of a combination of gradation values (hereinafter, “immediately preceding frame gradation values”) corresponding to the inputted image signals of the immediately preceding frame and gradation values (hereinafter, “current frame gradation values”) corresponding to the inputted image signals of the current frame. As described above, there are overshoot LUTs for the respective colors in the present embodiment. FIG. 4 schematically shows one example of the R overshoot LUT 160R. FIG. 5 schematically shows one example of the G overshoot LUT 160G. FIG. 6 schematically shows one example of the B overshoot LUT 160B.

The overshoot LUTs will be explained using FIG. 4. In FIG. 4, the values in the leftmost column show the immediately preceding frame gradation values, and the values in the uppermost row show the current frame gradation values. The value where each row and each column intersect each other is a gradation value (hereinafter, “output gradation value”) corresponding to the driving voltage determined on the basis of the combination of the respective immediately preceding frame gradation values and the respective current frame gradation values. When the immediately preceding frame gradation value is “64” and the current frame gradation value is “128,” then the output gradation value is “155,” for example. When the immediately preceding frame gradation value is “160” and the current frame gradation value is “64,” then the output gradation value is “20,” for example. In the present embodiment, overshoot driving is performed with the output gradation value as the overshoot parameter. In this manner, a driving voltage that is higher or lower than the gradation voltage corresponding to the inputted image signal of the current frame is applied to the liquid crystal on the basis of the data stored in the overshoot LUTs. In the present embodiment, each color has one of the overshoot LUTs, and thus, it is possible to differentiate the output gradation values, or overshoot parameter values, corresponding to any combination of the immediately preceding frame gradation values and the current frame gradation values for each of the colors.

When overshoot driving is being performed, the actual applied voltage to the liquid crystal for each of the pixel forming areas is determined on the basis of the combination of the immediately preceding frame gradation values and the current frame gradation values. Therefore, it is necessary to store data containing one frame's worth of the immediately preceding frame gradation values. The frame memory 150 for storing data containing one frame's worth of the immediately preceding frame gradation values is disposed in the liquid crystal display device that uses overshoot driving.

### 1.3 Relationship Between White Balance Parameter and Overshoot Parameter

In the present embodiment, the overshoot parameters are configured for each color on the basis of the three overshoot LUTs. Specifically, each of R, G, and B have overshoot parameters such that, the more the white balance parameter of a particular color has a maximum value corresponding to applied voltage to liquid crystal lowered by the white balance adjustment, the more the signal time shift will be emphasized through correction by the overshoot driving circuit 130. As shown by the row with reference character 141 in FIG. 3, G has a white balance parameter whose maximum value of applied voltage to liquid crystal is markedly lower than R or B. Thus, G has an overshoot parameter to greatly emphasize the signal time shift thereof by overshoot driving to a greater extent than R or B. If the immediately preceding frame gradation value is “32,” and the current frame gradation value is “96,” for example, the overshoot parameter value for R is “146” (see FIG. 4), “155” for G (see FIG. 5), and “145” for B (see FIG. 6).

### 1.4 Effects

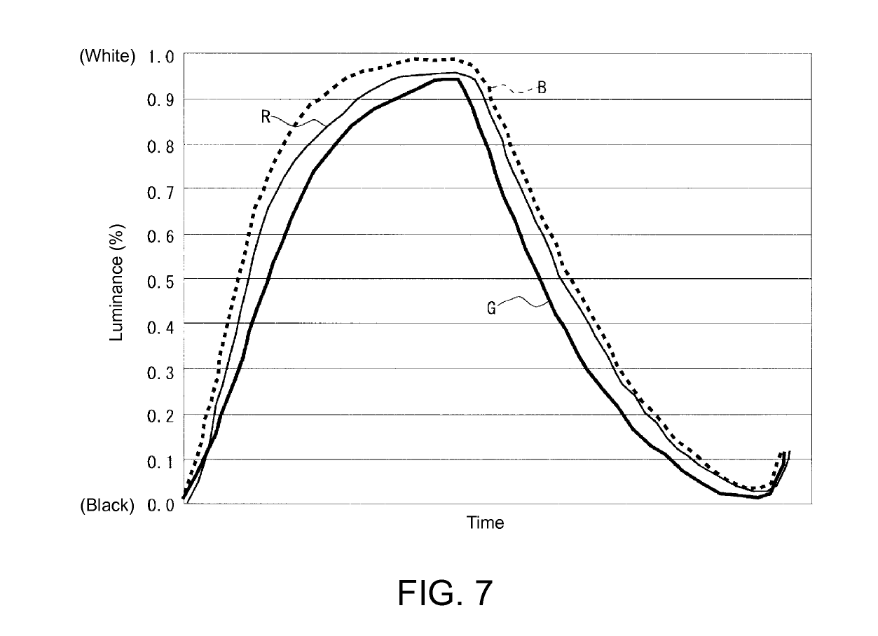

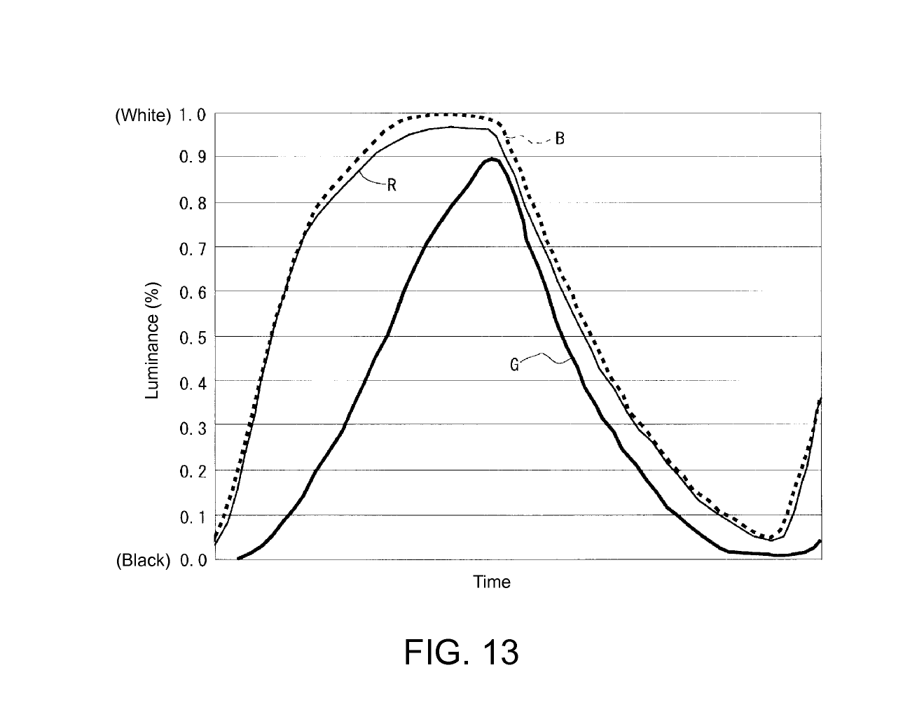

According to the present embodiment, there are three overshoot LUTs (the R overshoot LUT 160R, the G overshoot LUT 160G, and the B overshoot LUT 160B) in the display control circuit 100 so that overshoot parameters can be configured for each color. The overshoot parameters are configured for each color such that, the more the white balance parameter of a particular color has a maximum value corresponding to applied voltage to liquid crystal lowered by the white balance adjustment, the more the signal time shift will be emphasized. Accordingly, colors having the applied voltage to liquid crystal thereof lowered overall by white balance adjustment will have a suppression in the reduction in response speed (of liquid crystal) caused by a reduction in applied voltage to liquid voltage. The change in brightness for each color when black display and white display are repeated for each frame is as shown in FIG. 13 in the conventional configuration, for example, but FIG. 7 in the present embodiment. In this manner, the difference in response speed of liquid crystal among RGB becomes smaller regardless of differences in values in the white balance parameters among RGB. As a result, hues during moving image display can approximate hues during still image displays. As described above, the difference between hues during still image display and moving image display in a liquid crystal display device that performs white balance adjustment can be reduced.

### 2. Embodiment 2

### 2.1 Configuration, Etc.

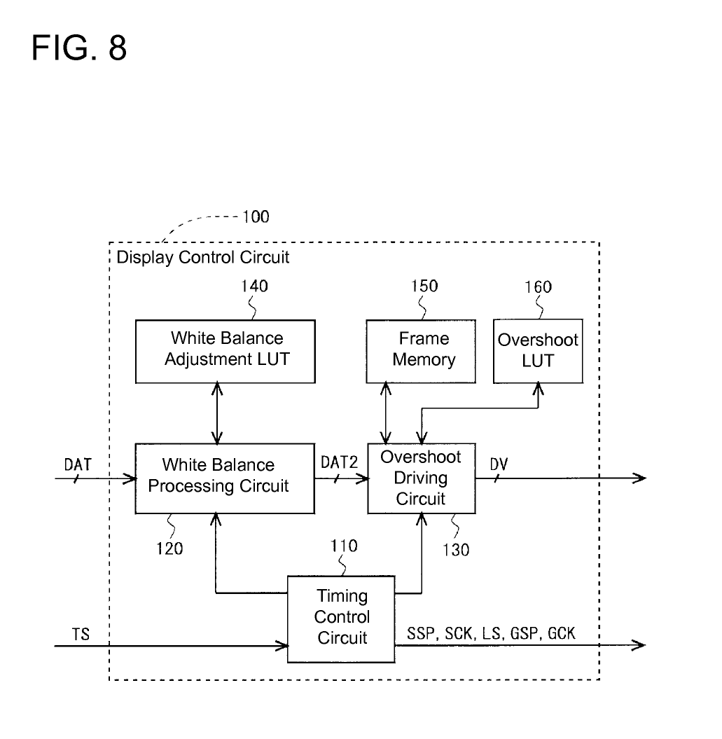

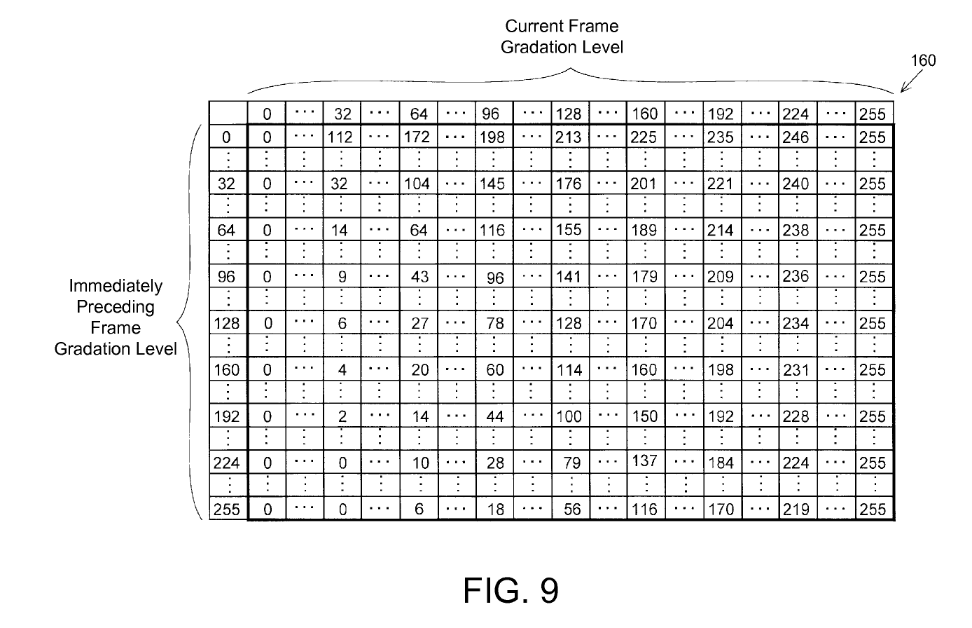

Next, Embodiment 2 of the present invention will be described. Only points of Embodiment 2 that are different from Embodiment 1 will be explained, and an explanation of points besides these will be omitted. FIG. 8 shows a block view of the configuration of a display control circuit 100 of the present embodiment. In the present embodiment, unlike in Embodiment 1 described above, a single overshoot LUT 160 is provided in a display control circuit 100. In this overshoot LUT 160, an output gradation value corresponding to the combinations of the respective immediately preceding frames and the current frames in this overshoot LUT 160 is shown in FIG. 9, for example.

### 2.2 About Overshoot Parameters

In Embodiment 1, the output gradation value for each overshoot LUT provided for each color was used for overshoot driving as the overshoot parameter. In the present embodiment, however, overshoot driving is performed with the overshoot parameter being a value obtained by a calculation process based on the output gradation value of the overshoot LUT and a coefficient that is determined for each color. This is explained in detail below.

In the present embodiment, the coefficients for overshoot parameter calculation are determined for each color so that the overshoot parameter values can be different among RGB. Under these conditions, overshoot parameters for the respective colors are found by formula (1).

V=P+(Q−P)×C (1)

V represents the value used as the overshoot parameter, P represents the current frame gradation value, Q represents the output gradation value, and C represents the coefficient determined for the corresponding color.

The smaller the white balance parameter value of a particular color, the larger the coefficient is. As shown in FIG. 3, when the white balance parameter of G is smaller than the white balance parameters of R and B, for example, then the coefficient of G is larger than the coefficients of R or B.

A method of finding the overshoot parameters will be explained using a case in which a coefficient Cr of R is “1.04,” a coefficient Cg of G is “1.20,” and a coefficient Cb of B is “1.0” as an example. The overshoot parameter value of each color when the immediately preceding frame gradation value is “32” and the current frame gradation value is “96” will be found on the basis of formula (1) above. This presupposes that the overshoot LUT 160 in FIG. 9 is being used. The calculated values are rounded down to the nearest decimal point.

Overshoot parameter value Vr for R:

$$\begin{matrix}Vr = 96 + ( 145 - 96 ) \times 1.04 \\ = 147\end{matrix}$$

Overshoot parameter value Vg for G:

$$\begin{matrix}Vr = 96 + ( 145 - 96 ) \times 1.20 \\ = 155\end{matrix}$$

Overshoot parameter value Vb for B:

$$\begin{matrix}Vr = 96 + ( 145 - 96 ) \times 1.00 \\ = 145\end{matrix}$$

In a similar manner, the overshoot parameter value of each color when the immediately preceding frame gradation value is “96” and the current frame gradation value is “32” will be found as below.

Overshoot parameter value Vr for R:

$$\begin{matrix}Vr = 32 + ( 9 - 32 ) \times 1.04 \\ = 8\end{matrix}$$

Overshoot parameter value Vg for G:

$$\begin{matrix}Vr = 32 + ( 9 - 32 ) \times 1.20 \\ = 4\end{matrix}$$

Overshoot parameter value Vb for B:

$$\begin{matrix}Vr = 32 + ( 9 - 32 ) \times 1.00 \\ = 9\end{matrix}$$

As described above, overshoot parameters are found for each color using all of the combinations of the immediately preceding frame gradation values and the current frame gradation values. When the calculation results of formula (1) above exceeds “255,” the overshoot parameter value may be “255,” and when the calculation results of formula (1) above is smaller than “0,” the overshoot parameter value may be “0.”

### 2.3 Effects

According to the present embodiment, the overshoot parameters are found through a calculation process and coefficients for the overshoot parameter calculation are prepared for each color. The overshoot coefficients are determined for each color such that, the more the white balance parameter of a particular color has a maximum value corresponding to applied voltage to liquid crystal lowered by the white balance adjustment, the more the signal time shift will be emphasized. Therefore, in a manner similar to Embodiment 1, the difference in response speed of liquid crystal among RGB becomes smaller regardless of differences in values in the white balance parameters among RGB. Due to this, the difference between hues during still image display and moving image display in a liquid crystal display device that performs white balance adjustment can be reduced.

### 2.4 Modification Example

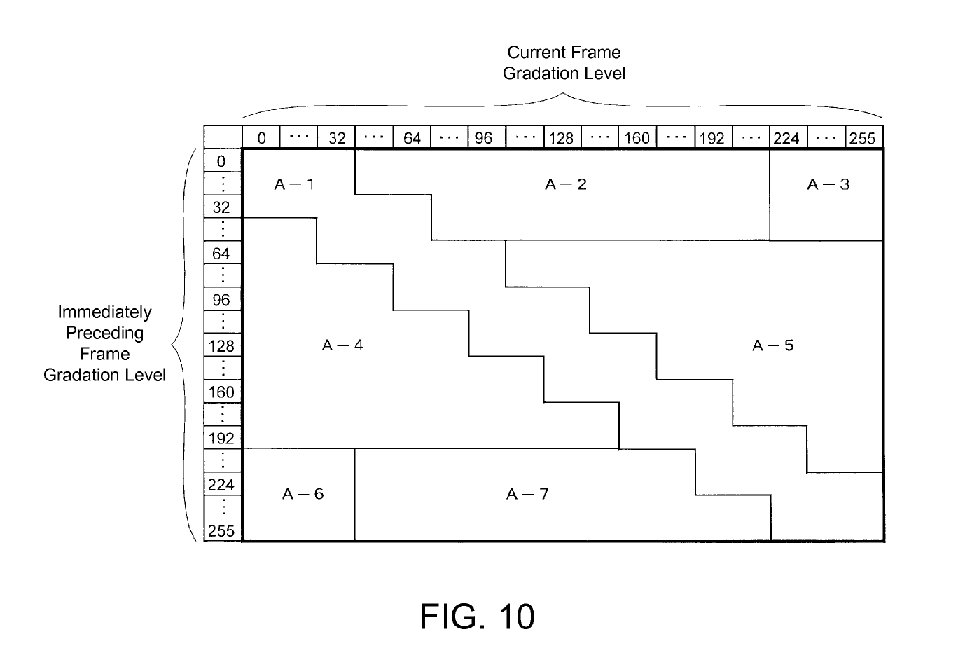

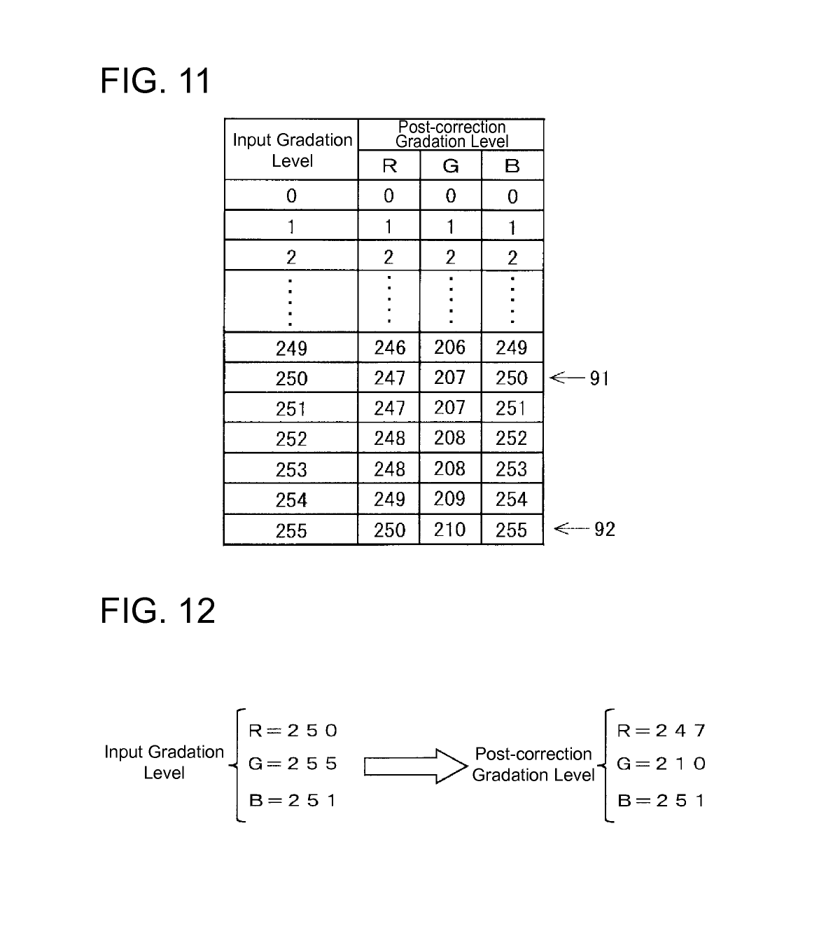

In Embodiment 2 described above, each of the colors had only one coefficient for overshoot parameter calculation. The present invention, however, is not limited to this, and each color may have a plurality of coefficients for overshoot parameter calculation. As shown in FIG. 10, for example, the combinations of the immediately preceding frame gradation values and the current frame gradation values may be divided into seven from “A-1” to “A-7” and coefficients may be assigned to each of these divisions. This makes it possible to more precisely adjust the degree of emphasis of the signal time shift by the overshoot driving, which allows for the difference between hues during still image display and hues during moving image display to be more effectively reduced.

### DESCRIPTION OF REFERENCE CHARACTERS

100 display control circuit
110 timing control circuit
120 white balance processing circuit
130 overshoot driving circuit
140 white balance adjustment LUT
150 frame memory
160 overshoot LUT
160R R overshoot LUT
160G G overshoot LUT
160B B overshoot LUT
200 source driver (image signal line driving circuit)
300 gate driver (scan signal line driving circuit)
400 display unit

1: A display control circuit that generates gradation data to be written to a liquid crystal display panel that displays images on the basis of image signals expressing gradation levels for colors, the display control circuit comprising:
a white balance processing unit that corrects the gradation level of each color expressed by the image signals using white balance parameters determined for each of the gradation levels of each color; and
an overshoot driving unit that generates the gradation data to be actually written for image display and generates a corresponding voltage applied to the liquid crystal display panel, the overshoot driving unit generating, for each of the colors, prescribed overshoot parameters as the actual gradation data to be written in accordance with a current frame gradation level to be applied in the current frame and a gradation level that has been written in an immediately preceding frame so as to emphasize a gradation level change,
wherein among the respective colors, the more the white balance processing unit decreases a maximum gradation level of a particular color, the greater the overshoot driving unit emphasizes the gradation level change for that particular color.

2: The display control circuit according to claim 1, further comprising:
for each of the colors, overshoot tables defined by:
a current frame gradation level to be applied in a current frame;
a gradation level that has been written in an immediately preceding frame; and
an overshoot parameter for every combination of current frame gradation level and a gradation level that has been written in an immediately preceding frame,
wherein the overshoot driving unit reads the overshoot parameter from the overshoot table of the corresponding color to generate gradation data to be actually written for image display.

3: The display control circuit according to claim 1,
wherein the overshoot driving unit emphasizes the gradation level change of the respective colors using a calculation including a product of a current frame gradation level to be applied in a current frame and a prescribed coefficient of the corresponding color as an overshoot parameter to generate gradation data to be actually written for image display.

4: The display control circuit according to claim 3,
wherein, for each color, the overshoot parameter is found by the calculation in a formula: V=P+(Q−P)×C, and
wherein V represents the overshoot parameter, P represents a gradation level that has been written in an immediately preceding frame, Q represents a current frame gradation level to be applied in a current frame, and C represents the coefficient of the corresponding color.

5: The display control circuit according to claim 3,
wherein a plurality of the coefficients are stored for each of the colors, and
wherein, for each color, the overshoot driving unit selectively uses one of the plurality of stored coefficients in accordance with a gradation level in an immediately preceding frame and a current frame gradation level to be applied in a current frame in performing said calculation.

6: A liquid crystal display device, comprising:
the display control circuit according to claim 1;
a liquid crystal display panel, including:
a plurality of image signal lines that transmit a plurality of image signals corresponding to the write gradation data for image display;
a plurality of scan signal lines that intersect with the plurality of image signal lines;
a plurality of pixel forming areas arranged in a matrix along the plurality of image signal lines and the plurality of scan signal lines; and
a common electrode that applies a common voltage to the plurality of pixel forming areas;
an image signal driving circuit that drives the plurality of image signal lines; and
a scan signal driving circuit that drives the plurality of scan signal lines.

7: A method of controlling display in which gradation data is generated that is to be written to a liquid crystal display panel that displays images on the basis of image signals expressing gradation levels for colors, the method comprising:
performing white balance processing by adjusting the gradation level of each color expressed by the image signals using white balance parameters determined for each of the gradation levels of each color; and
performing overshoot processing by generating the gradation data to be actually written for image display and generating a corresponding voltage applied to the liquid crystal display panel, said overshoot processing generating, for each of the colors, prescribed overshoot parameters as the actual gradation data to be written in accordance with a current frame gradation level to be applied in the current frame and a gradation level that has been written in an immediately preceding frame so as to emphasize a gradation level change,
wherein among the respective colors, the more a maximum gradation level of of a particular color is decreased in the step of white balance processing, the greater the gradation level change for that particular color is emphasized in the step of overshoot processing.
